(19) United States
(12) Patent Application Publication
(10) Pub. No.: US 2014/0043282 A1
(43) Pub. Date: Feb. 13, 2014

(54) CAPACITIVE TOUCH APPARATUS AND SENSING METHOD THEREOF

(71) Applicant: WINPOWER OPTRONICS CORPORATION, Hsinchu County (TW)

(72) Inventors: Yao-Hung Lai, Taichung City (TW); Chih-Hsiung Chen, Taoyuan County (TW); Chih-Wen Lu, Hsinchu City (TW); Hsuan-Lun Kuo, Tainan City (TW)

(73) Assignee: WinPower Optronics Corporation, Hsinchu County (TW)

(21) Appl. No.: 13/709,077

(22) Filed: Dec. 10, 2012

(30) Foreign Application Priority Data
Aug. 8, 2012 (CN) 201210280481.7

(51) Int. Cl. G06F 3/044

(52) U.S. Cl. CPC G06F 3/044
USPC 345/174; 178/18.06

(57) ABSTRACT

A capacitive touch apparatus and a sensing method thereof are provided. The capacitive touch apparatus includes an electrostatic detection panel, and a sensing device. The sensing device is coupled to the electrostatic detection panel, and configured to sense a variation of electrostatic field on the electrostatic detection panel, and generate at least one touch sensing signal accordingly.

### CROSS-REFERENCE TO RELATED APPLICATION

This application claims the priority benefit of China application serial no. 201210280481.7, filed on Aug. 8, 2012. The entirety of the above-mentioned patent application is hereby incorporated by reference herein and made a part of this specification.

### BACKGROUND

1. Technical Field

The present invention relates to a sensing technique, and more particularly, to a capacitive touch apparatus and a sensing method thereof.

2. Description of Related Art

The principle of a projective capacitive touch panel is to mainly detect a “variation of capacitance” of each sensing capacitor which is affected by the electrostatic capacitance of a finger and formed between the corresponding XY electrode in the projective capacitive touch panel. The manners of touch positioning (sensing) of the projective capacitive touch panel generally include a Self-capacitance and a Mutual-capacitance.

However, the touch positioning (sensing) of the self-capacitance and mutual-capacitance nowadays requires an independent excitation signal (e.g., a square wave pulse) to charge the relative capacitors. Additionally, a variation of capacitance is very small before and after a touch (only a few pF approximately), so that the variation of the sensing signals respectively sensed before and after a touch is too small (only a few mV approximately), and thus a signal-to-noise ratio (SNR) is too small and it is difficult to accurately determine whether a touch event has occurred. In order to increase the SNR to enhance the accuracy of touch positioning (sensing), the amplitude of the excitation signal (square wave pulse) may be increased directly. However, additional power and cost are created with such act.

### SUMMARY

Accordingly, an embodiment of the present invention provides a capacitive touch apparatus, which includes an electrostatic detection panel and a sensing device. The sensing device is coupled to the electrostatic detection panel, and configured to sense a variation of electrostatic field on the electrostatic detection panel, so as to generate at least one touch sensing signal accordingly.

According to an embodiment of the present invention, the electrostatic detection panel has at least one sensing electrode. The sensing device includes at least one sensing unit, which is configured to sense the variation of electrostatic field on the sensing electrode, so as to generate the touch sensing signal.

According to an embodiment of the present invention, the sensing unit changes an amplitude of the touch sensing signal according to the variation of electrostatic field on the sensing electrode.

According to an embodiment of the present invention, the at least one touch sensing signal includes a plurality of touch sensing signals. As such, the capacitive touch apparatus may further include a judgment unit, which is coupled to the sensing device, and configured to receive and process the plurality of touch sensing signals, and to determine whether a single-touch event or a multi-touch event has occurred on the electrostatic detection panel accordingly.

According to an embodiment of the present invention, the electrostatic detection panel may be implemented by adopting a projective capacitive touch panel.

Another embodiment of the present invention provides a sensing method, adapted to an electrostatic detection panel, which includes sensing a variation of electrostatic field on at least one sensing electrode of the electrostatic detection panel, so as to obtain a sensing result and generating at least one touch sensing signal according to the sensing result.

According to an embodiment of the present invention, when of the electrostatic field on the sensing electrode is varied, the touch sensing signal has a first amplitude. When the electrostatic field on the sensing electrode does not vary, the touch sensing signal has a second amplitude. The first amplitude is different from the second amplitude.

As described above, in the present invention, the touch positioning (sensing) of the projective capacitive touch panel is performed by sensing whether the electrostatic field on each sensing electrode in the electrostatic detection panel is varied or not (rather than utilizing a conventional method of sensing a variation of capacitance). The energy of electrostatic field on each sensing electrode in the electrostatic detection panel usually has several kV. Therefore, the present invention may obtain a better SNR without utilizing independent excitation signal, so that whether or not a touch event has occurred is simply and accurately determined.

In order to make the aforementioned features and advantages of the present invention more comprehensible, embodiments accompanying figures are described in detail below.

It should be understood, however, that this Summary may not contain all of the aspects and embodiments of the present invention, is not meant to be limiting or restrictive in any manner, and that the invention as disclosed herein is and will be understood by those of ordinary skill in the art to encompass obvious improvements and modifications thereto.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the invention.

FIG. 1 is a diagram illustrating a capacitive touch apparatus 10 according to an embodiment of the invention.

FIG. 2 is a schematic diagram illustrating an embodiment of a sensing unit 107 in FIG. 1.

FIG. 3 is a schematic diagram illustrating a sensing unit 107 of FIG. 1 according to another embodiment of the invention.

FIG. 4 is a schematic diagram illustrating a sensing unit 107 of FIG. 1 according to another embodiment of the present invention.

FIG. 5 is a flow chart illustrating a method for sensing the electrostatic detection panel according to an embodiment of the present invention.

### DESCRIPTION OF EMBODIMENT

Reference will now be made in detail to the present preferred embodiments of the invention, examples of which are illustrated in the accompanying drawings. Wherever possible, the same reference numbers are used in the drawings and the description to refer to the same or like parts.

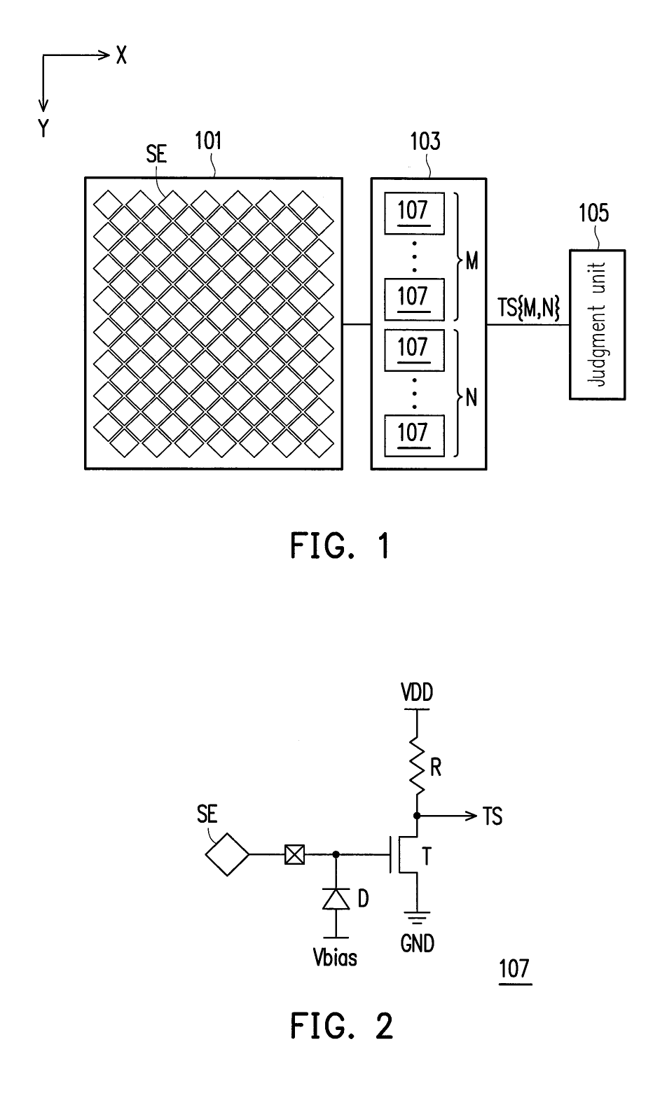

FIG. 1 is a diagram illustrating a capacitive touch apparatus 10 according to an embodiment of the invention. With reference to FIG. 1, the capacitive touch apparatus 10 includes an electrostatic detection panel 101, a sensing device 103, and a judgment unit 105. The electrostatic detection panel 101 may be implemented by adopting a projective capacitive touch panel, however it is not limited thereto. Under such condition, the electrostatic detection panel 101 may include M+N XY sensing electrodes SE, wherein M*N represents a sensing resolution of the electrostatic detection panel 101, which may not be the same as a display resolution of the electrostatic detection panel 101.

In addition, the sensing device 103 is coupled between the electrostatic detection panel 101 and the judgment unit 105, which is configured to sense a variation of electrostatic field on the electrostatic detection panel 101 without utilizing any independent excitation signal, so as to generate a plurality of touch sensing signals TS{M,N} for the judgment unit 105 accordingly. To be specific, the sensing device 103 may include M+N sensing units 107 having the same configuration. The sensing units 107 respectively correspond to the M+N XY sensing electrodes SE of the electrostatic detection panel 101, and configured to sense the variation of electrostatic field on the M+N XY sensing electrodes SE correspondingly, so as to generate the touch sensing signals TS{M,N}.

As a result, the judgment unit 105 may receive (e.g., receiving through a multiplexing method, however it is not limited thereto) and process (e.g., an analog-to-digital conversion, however it is not limited thereto) the touch sensing signals TS{M,N} generated by the sensing device 103, and then determine whether a single-touch event or a multi-touch event has occurred on the electrostatic detection panel 101.

Since the configurations of all of the sensing units 107 are identical, a single sensing unit 107 would be taken for explanation herein to elaborate on the proposed scheme/concept of sensing the electrostatic field in the embodiment of the invention.

FIG. 2 is a schematic diagram illustrating an embodiment of a sensing unit 107 in FIG. 1. With reference to FIGS. 1 and 2, the sensing unit 107 illustrated in FIG. 2 corresponds to a certain (XY) sensing electrode SE of the electrostatic detection panel 101 (it is referred to herein as an “example sensing electrode” SE for the following descriptions), which includes a diode D, an N-Mental-Oxide-Semiconductor (NMOS) transistor T, and a resistor R. An anode of the diode D is coupled to a bias voltage Vbias, and a cathode of the diode D is coupled to the example sensing electrode SE.

A gate of the NMOS transistor T is coupled to the cathode of the diode D, and a source of the NMOS transistor T is coupled to a ground potential GND. A first terminal of the resistor R is coupled to a system voltage VDD, and a second terminal of the resistor R is coupled to a drain of the NMOS transistor T to generate the corresponding touch sensing signal TS. Under such condition, when a medium (e.g., a finger, however it is not limited thereto) approaches the example sensing electrode SE, the electrostatic field on the example sensing electrode SE is varied. For instance, assuming that the finger carries positive charges, the example sensing electrode SE will carry negative charges due to the attraction of the positive charges on the finger. Moreover, the charges of same type repel against each other, so the positive charges of the example sensing electrode SE flow toward the gate of the NMOS transistor T. Herein, a gate voltage (Vg) of the NMOS transistor T may be represented as the following equation 1,

Vg=∈AE/Cgs 1.

Wherein, ∈ is a dielectric constant of the medium, A is an area of the example sensing electrode SE, E is the energy of electrical fields, and Cgs is an equivalent capacitance of the gate-to-source of the NMOS transistor T.

Since the positive charges on the example sensing electrode SE flow toward the gate of the NMOS transistor T, the gate-to-source voltage (Vgs) of the NMOS transistor T increases (that is, Vgs=Vg+Vbias), and thus a drain current (Id) of the NMOS transistor T increases, so that the correspondingly generated touch sensing signal TS has a first amplitude, namely, Vds1, which may be represented as the following equation 2,

Vds1=VDD−(Id*R) 2.

Accordingly, the drain current (Id) of the NMOS transistor T may be viewed as the strength of electric fields. That is, the drain current (Id) of the NMOS transistor T increases as the finger moves closer to the example sensing electrode SE.

Alternatively, when the finger is away from the example sensing electrode SE, then the electrostatic field on the example sensing electrode SE does not vary. At the time, there are no positive charges flowing toward the gate of the example sensing electrode SE. Accordingly, there is no variation of electrostatic field on the example sensing electrode SE, hence the gate-to-source voltage (Vgs) of the NMOS transistor T equals the bias voltage Vbias (that is, Vgs=Vbias), such that the drain current (Id) of the NMOS transistor T decreases, so that the correspondingly generated touch sensing signal TS has a second amplitude, namely, Vds2, which may be represented as the following equation 3,

Vds2=VDD−(Id*R) 3.

Since the drain current (Id) of the NMOS transistor T in equation 2 is greater than the drain current (Id) of the NMOS transistor T in equation 3, the calculated Vds1 is less than the calculated Vds2. A difference of Vds1 and Vds2 (ΔV, that is a difference of the touch sensing signals TS between touched and untouched events) has at least a voltage that may range from a few tenths of volt to a few volt (it is not limited thereto) due to the reason that there are several kV of the energy of electrostatic field. Under such condition, the judgment unit 105 may built-in the Vds2 in advance, and accordingly the difference between Vds2 and the touch sensing signal TS outputted by the sensing unit 107 is determined, so as to obtain whether or not a touch event has occurred.

It should be noted that even though the sensing unit 107 of the above embodiment is illustrated by using the NMOS transistor T as an example, however, the embodiment of the present invention is not limited thereto. In other words, the NMOS transistor T in the sensing unit 107 may be replaced by a PMOS (P-Mental-Oxide-Semiconductor) transistor (that is, a complementary circuit of the illustration in FIG. 2), as long as the given operation of the sensing unit 107 is maintained. These alternative embodiments also belong within the scope of the embodiment of the present invention.

Furthermore, even though the above embodiments have set forth an embodied circuit configuration that realizes the sensing units 107, however, the embodiment of the invention is not limited thereto. In other words, the sensing units having other circuit configurations that are enable to change the amplitude of the touch sensing signal (TS) according to the variation of electrostatic field on the sensing electrode (SE) also fall within the scope of the embodiment of the present invention.

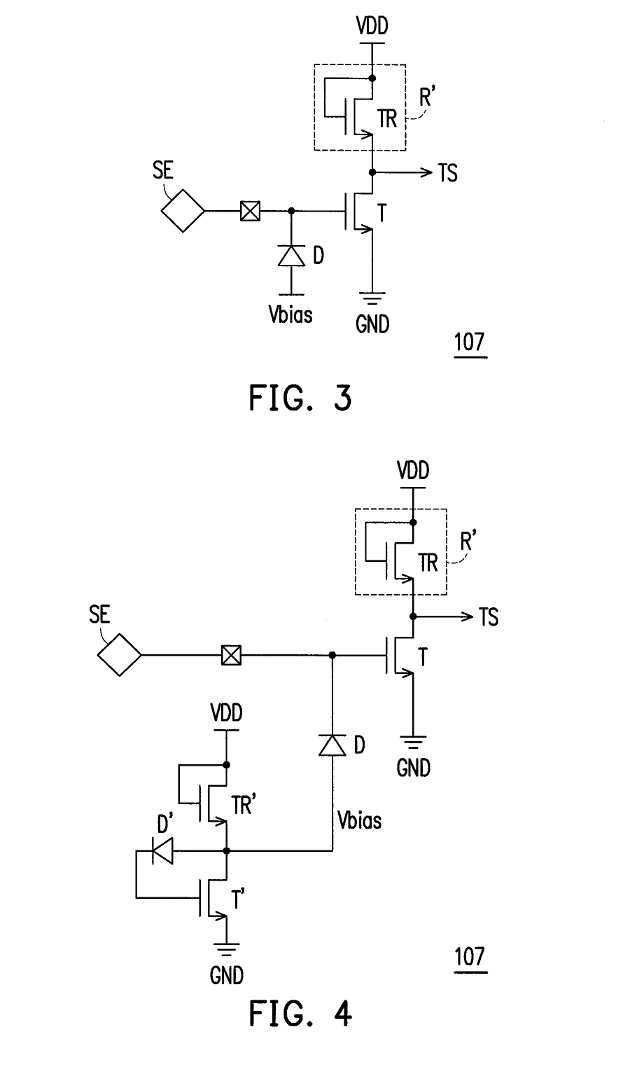

For example, FIG. 3 is a schematic diagram illustrating a sensing unit 107 of FIG. 1 according to another embodiment of the invention. With reference to FIGS. 2 and 3, the difference between the embodiments illustrated in FIGS. 2 and 3 is that the embodiment illustrated in FIG. 3 replaces a passive load (that is, a resistor R) illustrated in FIG. 2 with an active load R′. The active load R′ may be implemented by an NMOS transistor TR. A gate and a drain of the NMOS transistor TR are coupled to the system voltage VDD, and a source of the NMOS transistor TR is coupled to the drain of the NMOS transistor T to generate a corresponding touch sensing signal TS. The operation of the embodiment illustrated in FIG. 3 is similar to the embodiment illustrated in FIG. 2, hence it is omitted here.

Alternatively, FIG. 4 is a schematic diagram illustrating a sensing unit 107 of FIG. 1 according to another embodiment of the present invention. With reference to FIGS. 3 and 4, the difference between the embodiments illustrated in FIGS. 3 and 4 is that the embodiment illustrated in FIG. 4 further includes a self-biasing characteristic. To be specific, comparing to FIG. 3, the embodiment shown in FIG. 4 further include two NMOS transistors T′ and TR′ and a diode D′. A gate and a drain of the NMOS transistor TR′ is coupled to the system voltage VDD, and a source of the NMOS transistor TR′ is coupled to an anode of the diode D to provide a bias voltage Vbias. An anode of the diode D′ is coupled to the source of the NMOS transistor TR′. A gate of the NMOS transistor T′ is coupled to a cathode of the diode D′, a drain of the NMOS transistor T′ is coupled to the source of the NMOS transistor TR′, and a source of the NMOS transistor T′ is coupled to the ground potential GND. The operation of the embodiment illustrated in FIG. 4 is similar to the embodiment of FIG. 2, hence it is omitted here.

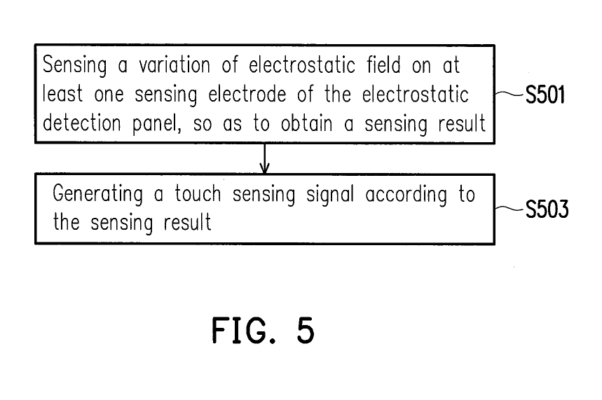

Based on the contents disclosed/taught by the above embodiment, FIG. 5 is a flow chart illustrating a method of sensing the electrostatic detection panel (which may be implemented by adopting a projective capacitive touch panel, but not limited thereto) according to an embodiment of the present invention. With reference to FIG. 5, the method of sensing the electrostatic detection panel includes the following steps. First, a variation of electrostatic field of at least one sensing electrode on the electrostatic detection panel is sensed, such that a sensing result is obtained (step S501). Then, at least one touch sensing signal is generated according to the sensing result obtained previously (step S503). Similarly, the generated touch sensing signal has a first amplitude when the electrostatic field on the sensing electrode is varied; the generated touch sensing signal has a second amplitude when the electrostatic field on the sensing electrode is not varied; and the first amplitude is different from the second amplitude.

In summary, in the present invention, the touch positioning (sensing) of the projective electrostatic detection panel is performed by sensing whether the electrostatic field on each (XY) sensing electrode in the electrostatic detection panel is varied or not (rather than utilizing a conventional method of sensing a variation of capacitance). Since the energy of electrostatic field on each sensing electrode within the electrostatic detection panel is usually several kV, the embodiment of the present invention is capable of obtaining better signal-to-noise ratio (SNR) without utilizing independent excitation signal. Thus, whether or not a touch event has occurred is simply and accurately determined.

The previously described exemplary embodiments of the present invention have the advantages aforementioned, wherein the advantages aforementioned not required in all versions of the invention.

Although the present invention has been described with reference to the above embodiments, however, the present invention is not limited thereto. It will be apparent to those skilled in the art that various modifications and variations can be made to the configuration of the disclosure without departing from the scope or spirit of the disclosure. In view of the foregoing, it is intended that the disclosure cover modifications and variations of this disclosure provided they fall within the scope of the following claims and their equivalents.

What is claimed is:

1. A capacitive touch apparatus, comprising:
an electrostatic detection panel; and
a sensing device, coupled to the electrostatic detection panel, and configured to sense a variation of electrostatic field on the electrostatic detection panel, and generate at least one touch sensing signal accordingly.

2. The capacitive touch apparatus as claimed in claim 1, wherein the electrostatic detection panel comprises at least one sensing electrode, and the sensing device comprising:
at least one sensing unit, configured to sense the variation of electrostatic field on the sensing electrode, so as to generate the touch sensing signal.

3. The capacitive touch apparatus as claimed in claim 2, wherein the sensing unit comprises:
a diode, having an anode coupled to a bias voltage, and a cathode coupled to the sensing electrode;
an NMOS transistor, having a gate coupled to the cathode of the diode, and a source coupled to a ground potential; and
a resistor, having a first terminal coupled to a system voltage, and a second terminal coupled to a drain of the NMOS transistor to generate the touch sensing signal.

4. The capacitive touch apparatus as claimed in claim 2, wherein the sensing unit comprises:
a first diode, having an anode coupled to a bias voltage, and a cathode coupled to the sensing electrode;
a first NMOS transistor, having a gate coupled to the cathode of the first diode, and a source coupled to a ground potential; and
a second NMOS transistor, having a gate and a drain coupled to a system voltage, and a source coupled to a drain of the first NMOS transistor to generate the touch sensing signal.

5. The capacitive touch apparatus as claimed in claim 4, wherein the sensing unit further comprises:
a third NMOS transistor, having a gate and a drain coupled to the system voltage, and a source coupled to the anode of the first diode to provide the bias voltage;
a second diode, having an anode coupled to the source of the third NMOS transistor; and
a fourth NMOS transistor, having a gate coupled to a cathode of the second diode, a drain coupled to the source of the third NMOS, and a source coupled to the ground potential.

6. The capacitive touch apparatus as claimed in claim 1, wherein the sensing device senses the variation of electrostatic field on the electrostatic detection panel without utilizing an independent excitation signal.

7. The capacitive touch apparatus as claimed in claim 6, wherein:
when a medium approaches the sensing electrode, the electrostatic field on the sensing electrode is varied, so as to make the touch sensing signal have a first amplitude;
when the medium does not approach the sensing electrode, the electrostatic field on the sensing electrode is not varied, so as to make the touch sensing signal have a second amplitude; and
the first amplitude is different from the second amplitude.

8. The capacitive touch apparatus as claimed in claim 2, wherein the sensing unit changes an amplitude of the touch sensing signal according to the variation of electrostatic field on the sensing electrode.

9. The capacitive touch apparatus as claimed in claim 1, wherein the at least one touch sensing signal comprises a plurality of touch sensing signals, and the capacitive touch apparatus further comprising:
a judgment unit, coupled to the sensing device, and configured to receive and process the touch sensing signals, and to determine whether a single-touch event or a multi-touch event has occurred on the electrostatic detection panel accordingly.

10. A sensing method, adapted to an electrostatic detection panel, the sensing method comprising:
sensing a variation of electrostatic field on at least one sensing electrode of the electrostatic detection panel, so as to obtain a sensing result; and
generating a touch sensing signal according to the sensing result.
